(19) United States
(12) Patent Application Publication
(10) Pub. No.: US 2008/0244716 A1
(43) Pub. Date: Oct. 2, 2008

(54) TELECOMMUNICATION SYSTEM, TELECOMMUNICATION METHOD, TERMINAL THEREOF, AND REMOTE ACCESS SERVER THEREOF

(76) Inventor: JUN GOTO, Tokyo (JP)

Correspondence Address: NEC CORPORATION OF AMERICA, 6535 N. STATE HWY 161, IRVING, TX, 75039, US

(21) Appl. No.: 12/055,709

(22) Filed: Mar. 26, 2008

(30) Foreign Application Priority Data
Mar. 30, 2007 (JP) 91708/2007

(51) Int. Cl. G06F 7/04

(52) U.S. Cl. 726/5

(57) ABSTRACT

Telecommunication system comprises a terminal and a relay device which relays a communication path established on a network by the terminal, wherein the relay device sends certification information based on a demand of the terminal and the terminal checks whether the certification information is correct or not and the terminal establishes a communication path on the network when the certification information is correct.

This patent application is based on Japanese Patent Application No. 2007-091708 filed on Mar. 30, 2007. The disclosure of Japanese Patent Application is incorporated herein by reference.

### BACKGROUND OF THE INVENTION

The present invention relates to a telecommunication system, a telecommunication method, a terminal thereof, and a remote access server thereof, and more particularly to a telecommunication system, a telecommunication method, a terminal thereof, and a remote access server thereof whereby security performance can be improved.

In recent years, information security risk, such as information leakage caused by a computer virus and by an unauthorized operation to the server in a telecommunication system which has a network such as an internet is rising.

Generally, in a network such as an intranet used for in-house communication, a unified security policy is applied to clients. And a network which a unified security policy is applied to is monitored and managed.

Therefore, terminals always connected to the in-house network are subjected to a security measure and thereby are in a state having a very low risk of infection of a virus etc.

As a relevant technology, JP-A 20006-2686180 discloses a telecommunication system where communication is performed between the server and the terminal on a network of an intranet etc.

JP-A 2006-268618 discloses a technology of a telecommunication system which is equipped with a server and a terminal capable of communicating with this server, wherein, when a certification ID given to the terminal is the same as certification ID previously registered, the server communicates with the terminal.

In telecommunication systems, with a lightening terminal such as a note-sized personal computer, a case is increasing, such as taking a terminal outside a company and using a network other than an in-house network, establishing connection with the in-house network through a remote access server.

Generally, as is shown in FIG. 12, this kind of telecommunication system comprises a terminal 1 which has a communication establishment element for establishing a communication path on the Internet 3 and a relay device for relaying the communication path, such as a broadband router. Moreover, an intranet 5 is connected with the network, for example, through an unillustrated router.

Usually, the terminal is connected to another network. It is also possible to take the terminal to the outside of the company and connect it to the Internet through a broadband router 2 etc.

When the terminal 1 establishes the communication path to the file server 50 on the intranet 5 while being connected to the broadband router 2, the establishment of the communication path is done through a remoter access server 4.

The remote access server 4 has the user certification element 4a. Upon acceptance of a remote access demand from the terminal 1 to the file server 50 in the intranet 5, the user certification element 4a performs certification of a user who has logged in the terminal 1 with user ID and password. Then, when the certification was performed correctly, the remote server 4 relays the communication path between the terminal 1 and the file server 50.

In this way, the user certification element 4a prevents any outsider from intruding into the in-house network from the Internet 3 side.

Conventionally, as a telecommunication system for enabling communication from the outside-company network to the in-house network, for example, a technology described in JP-A 2006-270273 and JP-A 2004-193988 are known.

A telecommunication system described in JP-A 20006-270273 has a user network and a service network capable of communicating with the user network through a transport network.

A managing server located in the service network performs certification of the terminal based on certification information sent thereto via a CPE (Customer Premises Equipment) located in a boundary between the user network and the transport network.

Moreover, the managing server sets filtering and tunneling on the CPE and the gateway router located in a boundary between the service network and the transport network based on this certification result.

JP-A 2004-193988 discloses a telecommunication system that, when the router is made to receive data of the in-house network in order to set the router existing in the outside-company network, the server reads an equipment ID of the router, and if this equipment ID is correct, the server sends the data to the router.

However, in the case of such a conventional telecommunication system, if the terminal such as a notebook-sized personal computer, which was taken to the outside against an operation manager's intention, was connected improvidently to a network whose security was not sufficiently guaranteed as in a public LAN, there was a fear of being infected with a virus and spyware.

Then, there was a problem that, when the terminal 1 is directly connected to the intranet 5 or is connected to the intranet 5 through the remote access server 4 in state of being infected with the virus and the spyware and communication is performed between the terminal 1 and the file server 50 of the intranet 5, the telecommunication system is affected by the various or the spyware and its security is weakened.

That is, because the terminal was a proper terminal, and its connection with the in-house network was also performed properly, there is a fear that unjust intrusion was made into the intranet through the terminal infected with a virus or spyware.

The present invention is provided to solve the problem as described above which the conventional technology has, and it is the object to provide a telecommunication system, a telecommunication method, a terminal thereof, and a remote access server thereof whose security performance is improved by preventing the terminal from connecting to the network improvidently.

### SUMMARY OF THE INVENTION

An object of the present invention is to provide a telecommunication system, a telecommunication method, a terminal thereof, and a remote access server thereof which can improve the security performance.

According to one aspect of the present invention, a telecommunication system comprising a terminal and a relay device which relays the communication path established on a network by the terminal, wherein the relay device sends certification information based on a demand of the terminal and the terminal checks whether the certification information is correct or not and the terminal establishes the communication path on the network when the certification information is correct.

According to one aspect of the present invention, telecommunication method in a system which has a terminal and a relay device which relays a communication path established on a network by the terminal, the telecommunication method comprising the step of: demanding the relay device to send certification information; checking whether the certification information is correct or not; and establishing a communication path on the network when the certification information is correct.

According to one aspect of the present invention, a terminal connected to a relay device which relays a communication path established on a network by the terminal, the terminal comprising: a communication establishment element which establishes a communication path on a network; a certification element which demands the relay device to send the certification information for the terminal and which permits the communication establishment element to establish a communication path on the network when the certification information received from the relay device is correct.

According to one aspect of the present invention, a remote access server in system which has a terminal and a relay device which relays a communication path established on network by the terminal, the remote access server comprising: a relay element which enables to relay a communication path between the network and other network; and a certification element which receives a remote access demand from the terminal and which permits the relay element to relay a communication path to a computer in the other network by checking that the received certification information is correct.

### BRIEF DESCRIPTION OF THE DRAWINGS

Other features and advantages of the invention will be made more apparent by the following detailed description and the accompanying drawings, wherein:

FIG. 1 is a schematic diagram showing a telecommunication system according to a first embodiment of the present invention;

FIG. 2 is a block diagram showing the telecommunication system;

FIG. 3 is a sequence diagram of the telecommunication system;

FIG. 4 is a flowchart diagram of a terminal of the telecommunication system;

FIG. 5 is a flowchart diagram of a remote access server of the telecommunication system;

FIG. 6 is a schematic diagram showing a telecommunication system according to a second embodiment of the present invention;

FIG. 7 is a block diagram showing the telecommunication system;

FIG. 8 is a sequence diagram of the telecommunication system;

FIG. 9 is a flowchart diagram of a terminal of the telecommunication system;

FIG. 10 is a flowchart diagram of a broadband router which is a relay device of the telecommunication system;

FIG. 11 is a flowchart diagram of a remote access server of the telecommunication system; and

FIG. 12 is a diagram showing one example of the telecommunication system in a relevant technology.

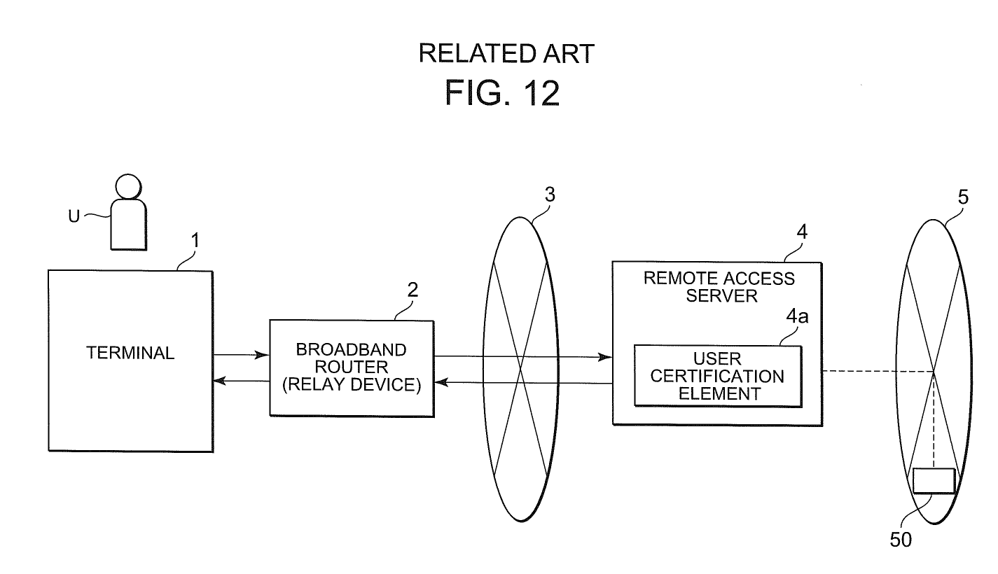

In the drawings, the same reference numerals represent the same structural elements.

### DETAILED DESCRIPTION OF THE PREFERRED EMBODIMENTS

The present invention will be described in detail below with reference to the accompanying drawings.

One of the features of the present invention is to provide a telecommunication system, a telecommunication method, a terminal thereof, and a remote access server thereof which can improve the security performance.

A first embodiment of the present invention will be described in detail below.

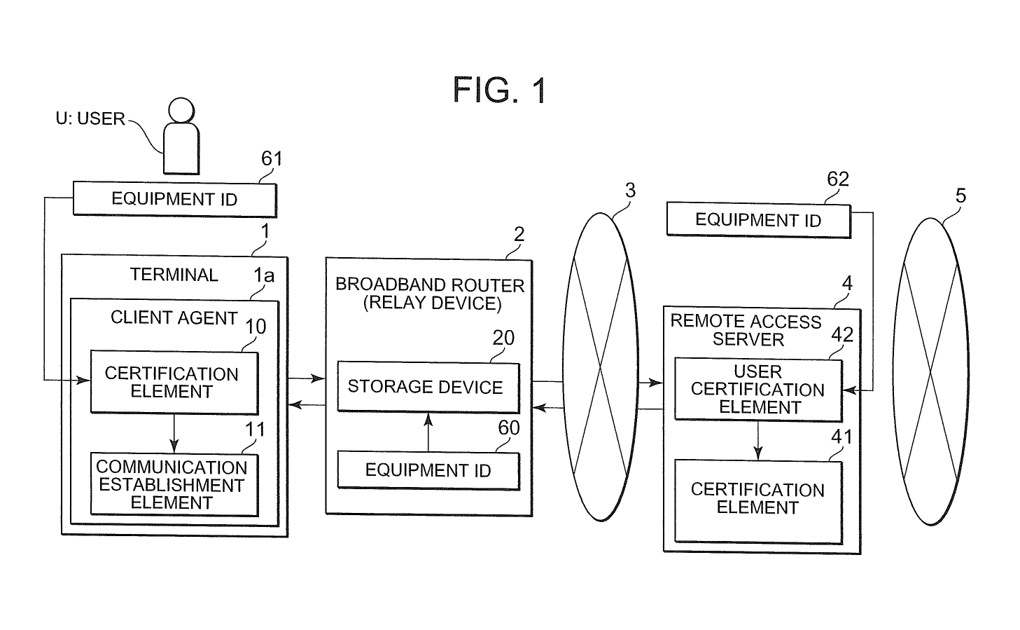

As shown in FIG. 1, the telecommunication system of this embodiment includes a terminal 1, a relay device 2, and a remote access server 4. The terminal 1 has a communication establishment element 1 for establishing the communication path on a network 3. The relay device 2 relays the communication path.

The remote access server 4 has a relay element 40 which can relay the communication path from the network 3 side to a computer in another network 5.

In this telecommunication system, a communication is performed after the communication path is established among nodes, such as the terminal 1, the relay device 2, and the remote access server 4. In this embodiment, the establishment of the communication path is performed using a protocol, such as TCP/IP, for example.

The terminal 1 is, for example, a portable computer such as a notebook-sized personal computer, and is used usually as a client computer of a terminal in another network 5.

The relay device 2 is composed of, for example, a hub, a router, etc., and is equipped with what is called a routing function, a bridge function, a switch function, etc. In this embodiment, the relay device 2 is a broadband router 2.

Information of the broadband router 2 is registered in advance at the time of manufacture by a manufacture vendor.

The information of the broadband router 2 is specific information of a device whereby the broadband router is uniquely identified, for example, an equipment ID of a serial number etc., a MAC address of the LAN-side port of the broadband router 2 which cannot be changed, etc. The equipment ID 60 is used in this embodiment.

The network is the Internet 3 which is one of so-called computer networks.

The remote access server 4 is, for example, a server device for relaying using an ISDN circuit or a VPN device for forming a VPN (virtual private network) on the existing network, etc.

The remote access server 4 has a function of, when an access from the Internet 3 side fulfills predetermined conditions, guiding this access to another network 5.

Another network is an intranet 5 such as an in-house network.

A computer in the intranet 5 is, for example, a host computer, such as a file server. In this embodiment, the computer in the intranet 5 is a file server 50.

A configuration of the telecommunication system will be explained below in more detail.

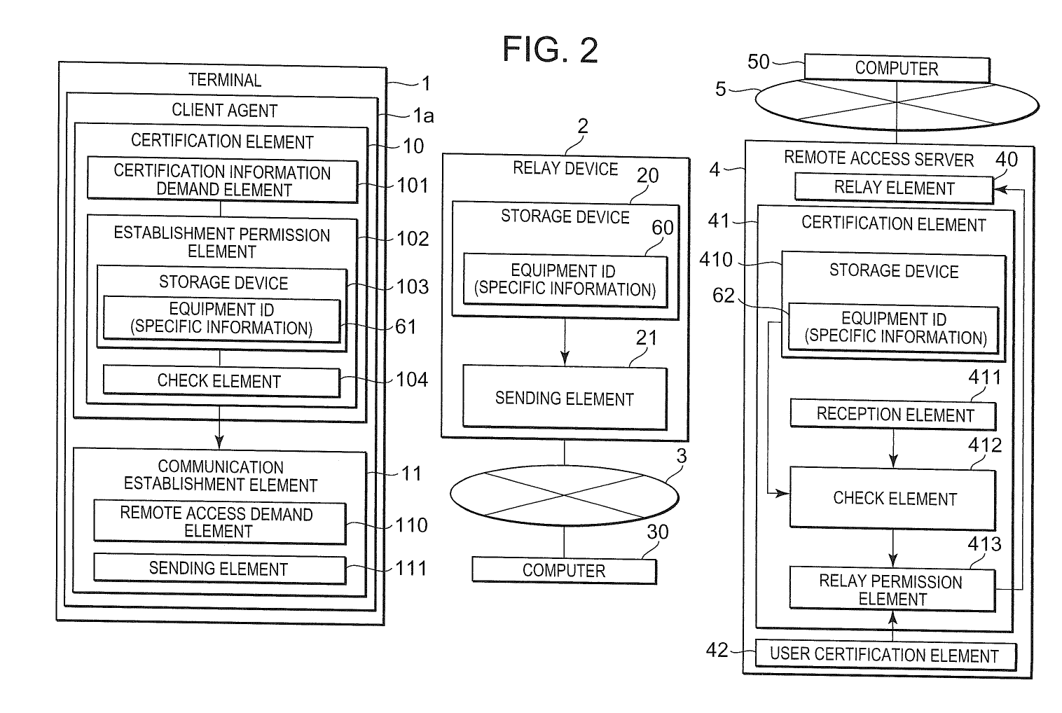

As shown in FIG. 2, the terminal 1 is equipped with a storage device such as a hard disk drive, and an arithmetic processing unit such as a CPU, memory, etc.

A client agent 1a having a certification element 10 and a communication establishment element 11 is installed in the terminal 1. When accessing to the Internet 3, the certification element 10 of terminal 1 receives the certification information from the broadband router 2 for relaying the communication path to be established on the Internet 3 side, and performs certification of the broadband router 2. The communication establishment element 11 can establish the communication path between the router 2 and the computer 30 on the network 3.

Moreover, the client agent 1a is software and is stored in advance in a storage device of the terminal 1. When the terminal 1 is activated, the client agent 1a is automatically read from the storage device, and is subjected to operation processing by an arithmetic processing unit, being made to operate.

The certification element 10 of terminal 1 has a certification information demand element 101 and an establishment permission element 102.

The certification information demand element 101 makes a demand for the broadband router 2 to send the certification information to the terminal 1. The establishment permission element 102 permits establishment of the communication path by the communication establishment element 11 if the certification information from the broadband router 2 is correct.

When being connected with the broadband router 2 by a transmission path, such as LAN cable, the certification information demand element 101 establishes the communication path between the terminal 1 and the broadband router 2, and sends a sending demand signal which is a demand to send the certification information to the broadband router 2. Then, upon reception of the certification information from the broadband router 2, the certification information demand element 101 sends the certification information to the establishment permission element 102.

If not receiving certification information in spite of transmitting the certification information from terminal 1 to relay device 2, the certification information demand element 101 sends the send information demand signal a predetermined number of times.

The certification information demand element 101 is making a demand to send to a nearest relay terminal of the terminal 1.

The establishment permission element 102 has a storage device 103 and a check element 104. The storage device 103 of terminal 1 stores specific information of the broadband router 2 to be permitted to connect (equipment ID 61). The check element 104 of terminal 1 finds that the certification information sent from the broadband router 2 is correct when the specific information stored in the storage device 103 and the certification information are in agreement.

The storage device 103 of terminal 1 is, for example, a hard disk drive with which the personal computer itself is equipped.

For example, a user U itself of the terminal 1 and a manager of the intranet 5 verifies a network environment on the LAN side of the broadband router 2 in advance. And when there is as good security as the above-mentioned intranet 5, the storage device 103 of terminal 1 stores an equipment ID 61 of the broadband router 2.

In the storage device 103 of terminal 1, a lot of the specific information of the relay device on the network whose security is high can be stored in this way. For example, it is desirable to also register specific information of the broadband router 2 which is interposed between the Internet 3 and the intranet 5.

When the certification information send from the certification information demand element 101 is in agreement with any one of the equipment ID's of the broadband router 2 stored in the storage device 103, the check element 104 finds that the certification information is correct.

Moreover, when the certification information is not the equipment ID stored in the storage device 103, the check element 104 finds that it is not correct and does not permits establishment of the communication path by the communication establishment element 11. In the result, the communication path between the terminal 1 and the Internet 3 side is not established.

Moreover, even when the certification information is unreceivable, the establishment permission element 102 does not permit the establishment of the communication path by the communication establishment element 11. In the result, communication path between the terminal 1 and the Internet 3 side is not established.

The communication establishment element 11 has a remote access demand element 110 and a sending element 111. The remote access demand element 110 demands of the remote access server 4 to establish the communication path to a computer in the intranet 5. The sending element 111 sends the certification information received from the broadband router 2 to the remote access server 4.

When the remote access demand element 110 demands a remote access of the remote access server 4, the communication establishment element 11 establishes the communication path up to the remote access server 4 on the Internet 3.

The remote access demand element 110 sends out a demand signal to demand remote access using the communication path established by the communication establishment element 11.

The sending element 111 of terminal 1 sends the certification information using the communication path up to the remote access server 4 established by the communication establish element 11. Moreover, the sending element 111 of terminal 1 temporarily stores the certification information sent from the broadband router 2 in memory or a hard disk drive, and sends this certification information to the remote access server 4.

In this embodiment, when the remote access demand element 110 demands establishment of the communication path to the computer 50 in the intranet 5, the sending element 111 of terminal 1 sends the certification information by making the demand signal sent out by the remote access demand element 110 include the certification information.

The broadband router 2 is set up in a home.

This broadband router 2 has a sending element 21 and a storage device 20. The sending element 21 sends the certification information in response to a demand sent from the terminal 1. The storage device 20 stores the specific information of the broadband router 2.

The storage device 20 of broadband router 2 is made up of, for example, ROM including an internal IC.

Upon reception of a demand signal of certification information from the terminal 1, the sending element 21 of broadband router 2 is sending specific information (equipment ID 60) stored in the storage device 20 of the broadband router 2 as certification information.

In this embodiment, the certification information is sent to the terminal 1 using the communication path established by the communication establishment element 11 of the terminal 1.

The remote access server 4 has a certification element 41. The certification element 41 finds whether or not the terminal to which a remote access demand is made exists in a network environment where security level is high.

The remote access server 4 has a storage device 410, a reception element 411, a check element 412, and a relay permission element 413.

The storage device 410 of the remote access server 4 stores an equipment ID 62 of the broadband router 2 which permits the relaying of the communication path. The reception element 411 receives the remote access demand from the remote access demand element 110 and the certification information from the sending element 111 of terminal 1. The check element 412 of remote access server 4 finds whether or not the certification information corresponding to the remote access demand received by the reception element 411 agrees with the specific information stored in the storage device 410 of remote access server 4. When the check element 412 of remote access server 4 found the agreement, the relay permission element 413 permits the relay element 40 to relay the communication path to the computer 50 in the intranet 5.

The storage device 410 of remote access server 4 is made up of a hard disk drive with which the remote access server 4 is equipped. Then, the storage device 410 of the remote access server 4 stores specific information of a relay device (for example, the equipment ID 62 of the broadband router 2) such that security of the network on the LAN side thereof was fully secured in advance by the user U or a network manager of the intranet 5.

The reception element 411 receives a demand signal sent through the communication path which is established by the communication establishment element 11, and takes out the certification information out of the demand signal.

The check element 412 of remote access server 4 finds whether or not the certification information taken out by the reception element 411 agrees with any one of the equipment ID's of the broadband routers 2 stored in the storage device 410.

When the check element 412 of remote access server 4 finds the agreement, the relay permission element 413 notifies permission to establish the communication path in the intranet 5 to the terminal 1 having sent out the demand signal of remote access corresponding to this certification information, and makes the relay element 40 guide remote access of this terminal 1 into the intranet 5.

The remote access server 4 has a user certification element 42. After the check element 412 finds the agreement, the user certification element 42 acquires the user certification information of the user U who logs on to the terminal 1 from the terminal 1, and performs the user certification. Then, when the user certification is performed correctly, the user certification element 42 makes a relay permission element 413 permit the relaying of the communication path by the relay element 40.

After the check element 433 finds the agreement, the user certification element 42 demands of the terminal 1 to send, for example, the user U's ID and a password corresponding to this ID.

Then, when the user ID and the password are sent from the terminal 1, the user certification element 42 finds whether they are correct or not by collating them with the user U's certification information stored in the storage device 410.

When the check element 433 of remote access server 4 finds the disagreement or when the user certification element 42 finds that the user ID and the password is not correct, the remote access server 4 notify the terminal 1 that the communication path cannot be established in the intranet 5.

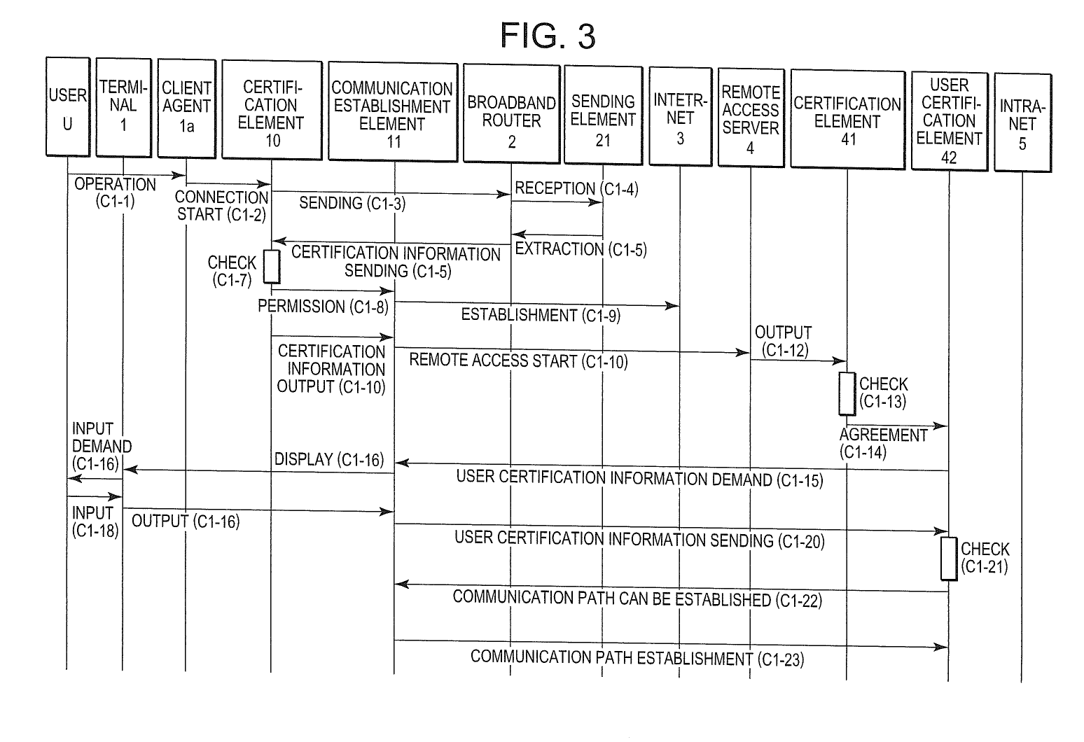

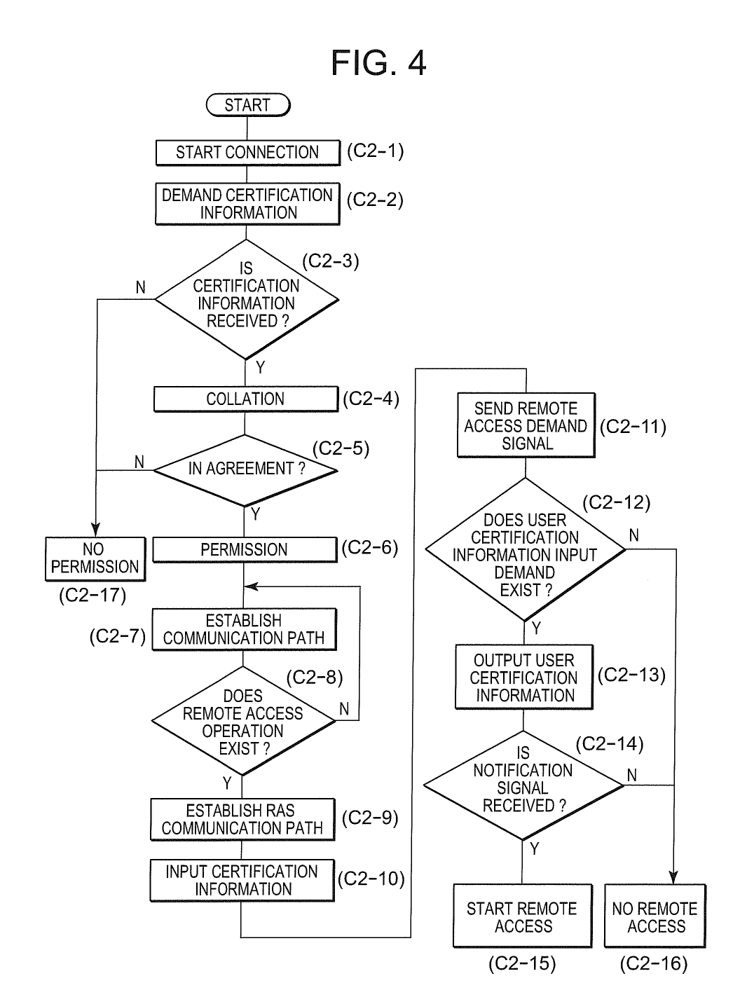

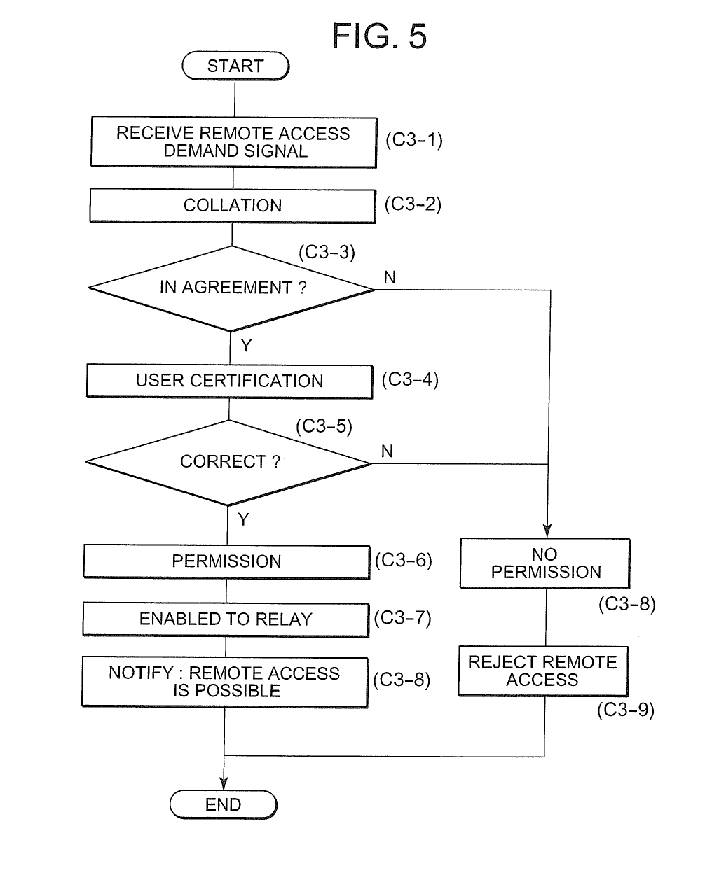

Next, operations of the telecommunication system of this embodiment which includes the above configuration will be explained with reference to charts shown in FIGS. 3-5. FIG. 3 shows a sequence diagram of the telecommunication system. FIG. 4 shows a flowchart diagram of the terminal 1. FIG. 5 shows a flowchart diagram of remote access server 4.

For example, user U takes the terminal 1 used in an intranet 5 and connects it with the broadband router 2 using a LAN cable.

When the terminal 1 is activated, a client agent 1a of the terminal 1 recognizes having been connected with the broadband router 2. In this time, since the communication establishment element 11 of the client agent 1a does not have permission from the establishment permission element 102, a connection with the Internet 3 is not established.

Next, when the terminal 1 performs first communication with the Internet 3 through the broadband router 2 by the user U's operation, the client agent 1a of the terminal 1 detects this (Step C1-2). Then, the certification information demand element 101 establishes the communication path between the terminal 1 and the broadband router 2, and sends a signal of demanding the certification information of the broadband router 2 (Steps 1-3, C2 2). When the broadband router 2 receives the signal demanding the certification information (Step C1 4), the sending element 21 of broadband router 2 takes out an equipment ID 60 from the storage device 20 of broadband router 2 (Step C1-5), and transfers this to the terminal 1 as certification information (Step C1-6).

Upon reception of the certification information (Step C2-3Y), the check element 104 of terminal 1 collates it with the equipment ID 61 stored in the storage device 103 of terminal 1 (Step C2-4). When there is a pair of the equipment ID stored in the storage device 103 and the certification information which are in agreement (Step C2-5Y), the establishment permission element 102 permits the communication establishment element 11 to establish the communication paths to the Internet 3 and to the network on the LAN side of the broadband router 2 (Steps C1-8, C2-6).

The terminal 1 becomes capable of establishing the communication path on the Internet 3 side by the communication establishment element 11, and performs communication with the Internet 3 side through this communication path (Steps C1-9, C2-7).

On the other hand, when, although the certification information demand element 101 sent the sending demand signal of certification information, the certification information could not be received, the certification information demand element 101 sends out the sending demand signal again. When the certification information cannot be received even if this was repeated a predetermined number of times (Step C2-3N), the certification information demand element 101 considers that the broadband router 2 does not have the certification information sending element 21. For this reason, the establishment permission element 102 does not permit the establishment of the communication paths either to the Internet 3 or to the network on the LAN side of the broadband router 2 by the communication establishment element 11 (Step C2-17).

Moreover, when the check element 104 of terminal 1 collates the certification information with the equipment ID stored in the storage device 103 of terminal 1 and finds that there is no equipment ID which agrees with the certification information (Steps C2-4, C2-5N), the establishment permission element 102 does not permit the establishment of the communication paths either to the Internet 3 or to the network on the LAN side of the broadband router 2 (Step C2-17).

Next, in the case where the user U peruses a file of the file server 50 in the intranet 5 with the terminal 1 (Steps C2-8Y, C2-9), the establishment becomes as follows. In this case, the certification information (equipment ID 60) is inputted into the sending element 111 of terminal 1 from the certification information demand element 101 (Step C1-10).

The communication establishment element 11 establishes the communication path between the terminal 1 and the remote access server 4 (Step C2-10). Then, in order to communicate with the file server 50, a demand signal of remote access is sent out to the remote access server 4 by the remote access demand element 110 (Steps C1-11, C2 11). In this time, the sending element 111 of terminal 1 includes the certification information in the demand signal.

When the reception element 411 of remote access server 4 receives the remote access demand signal from the remote access demand element 110 of the terminal 1, the reception element 411 takes out the certification information included in the demand signal (Step C3-1).

Next, the reception element 411 outputs a taken-out equipment ID to the check element 433 of the remote access server 4 (Step C1-12).

Upon receiving the certification information, the check element 412 of remote access server 4 collates the certification information (equipment ID 60) with the equipment ID 62 of the storage device 410 (Steps C1-13, C3-2). Next, when there is a pair of the equipment ID 62 stored in the storage device 410 and the certification information (equipment ID 60) which are in agreement (Steps C1-14, C3-3Y), the user certification element 42 sends out a signal demanding the user certification information composed of the user U's ID and the password to the terminal 1 (Steps C1-15, C3-4). When the remote access demand element 110 receives this signal, a window for inputting the user ID and the password is displayed on a display screen of the terminal 1 (Step C1-16), and the remote access demand element 110 demands of the user U to input them (Steps C1-17, C2-12Y).

When the user U inputs the user ID and the password (Step C1-18), the user certification information composed of them is outputted to the communication establishment element 11 (Step C1-19). Then, the communication establishment element 11 sends the user certification information to the remote access server 4 (Steps C1-20, C2-13).

Upon reception of the user certification information, the user certification element 42 finds whether it is correct or not. And if it is correct (Steps C1-21, C3-5Y), the user certification element 42 permits the relay permission element 413 to relay the communication path from the terminal 1 to the intranet 5 (Step C3-6).

Moreover, the certification element 41 of remote access server 4 sends out a signal notifying the communication establishment element 11 of the terminal 1 that the communication path can be established for the file server 50 in the intra net 5 (Steps C1-22, C3-7).

Then, upon reception of this notification signal (Step C2-14Y), the communication establishment element 11 establishes the communication path for the file server 50 in the intranet 5 and performs communication with the file server 50 (Steps C1-23, C2-15).

Moreover, when there is no pair of the equipment ID stored in the storage device 410 and the certification information, or when the user certification information is not correct (Step C3-5N), the check element 412 of remote access server 4 does not permit the relay element 40 to relay the communication path from the terminal 1 to the intranet 5. Then the user certification element 42 sends out a signal rejecting remote access to the terminal 1 (Steps C1-15, C3-9).

Upon reception of the remote access rejection signal (Steps C2-12N, C2-14N), the terminal 1 displays the fact on the screen. Then, the communication establishment element 11 becomes incapable of establishing the communication path for the file server 50, whereby no remote access can be made (Step C2-16).

As explained above, according to the telecommunication system concerning this embodiment, the certification information demand element 101 makes a demand to send the certification information to the broadband router 2. And when the establishment permission element 102 finds that this certification information is correct, the communication establishment element 11 establishes the communication path. For this reason, the terminal 1 becomes incapable of communicating with a computer of the Internet 3, a computer on the LAN side of the broadband router 2, etc. improvidently.

That is, in a state where the security of the network on the LAN side of the broadband router 2 is not fully secured, the terminal is incapable of communication. In the result, the terminal 1 is not infected with the virus and the spyware. In this telecommunication system, the security performance of the telecommunication system can be improved.

In the telecommunication system concerning this embodiment, when the specific information stored in the storage device 103 of terminal 1 and the certification information sent from the broadband router 2 are in agreement, the check element 104 of terminal 1 shall check that the certification information is correct. Therefore, if the equipment ID 61 of the broadband router 2 of the network whose security is fully secured in advance is stored in the storage device 103 of terminal 1, a risk that the terminal 1 will be infected with a virus and spyware is reduced considerably.

By this feature, even if the terminal 1 is brought to a company from a home and is used by being connected to the in-house intranet 5, since the risk that the terminal 1 will be infected with a virus and spyware is reduced considerably, there is almost no effect to the file server 50 in the intranet 5 and other computers; therefore, the security performance of the telecommunication system can be improved.

Moreover, since the remote access server 4 has the check element 412, when the terminal 1 accesses the intranet 5 from the outside of the intranet 5, even the remote access server 4 can perform certification of the certification information sent from the broadband router 2.

That is, whether or not the security of the network on the terminal 1 side from the broadband router 2 is excellent, is checked doubly.

By this check, since only when the network environment of the LAN side port of the broadband router 2 is excellent, the remote access server 4 is allowed to establish the communication path from the terminal 1 to the intranet 5 side. In the result, any access to the intranet 5 side from a network whose security is low does not exist even with the remote access server 4. Therefore, unjust intrusion on the intranet 5 side will not almost cease, which can improve the security performance.

Moreover, since the remote access server 4 receives the certification information of the broadband router 2 from the terminal 1, it becomes unnecessary to complicate a configuration of the broadband router 2 so much.

That is, different from a case where the broadband router 2 automatically sends the certification information to the remote access server 4 when being connected to the network, in this embodiment, the remote access server 4 receives the certification information only when the terminal 1 makes a remote access. In the result, the certification information becomes hard to be known by the outsider; for example, a fear that this intranet 5 is intruded by an unauthorized terminal 1 performing spoofing can be reduced.

Furthermore, in this embodiment, the telecommunication system is configured to acquire the certification information for the broadband router 2 which is nearest to the terminal 1. Because it is easy to make the security environment excellent provided that it is the nearest broadband router 2, the telecommunication system can be installed easily.

Still moreover, since the remote access server 4 also performs user certification, it can improve the security performance further.

Even moreover, since it becomes impossible for the terminal 1 itself to connect with a network improvidently, the terminal 1 itself becomes resistant to be infected with a virus and spyware. By this feature, a situation where the terminal 1 is used while being infected with a virus and spyware in the intranet 5 can be prevented.

Next, a second embodiment of the present invention will be described in detail.

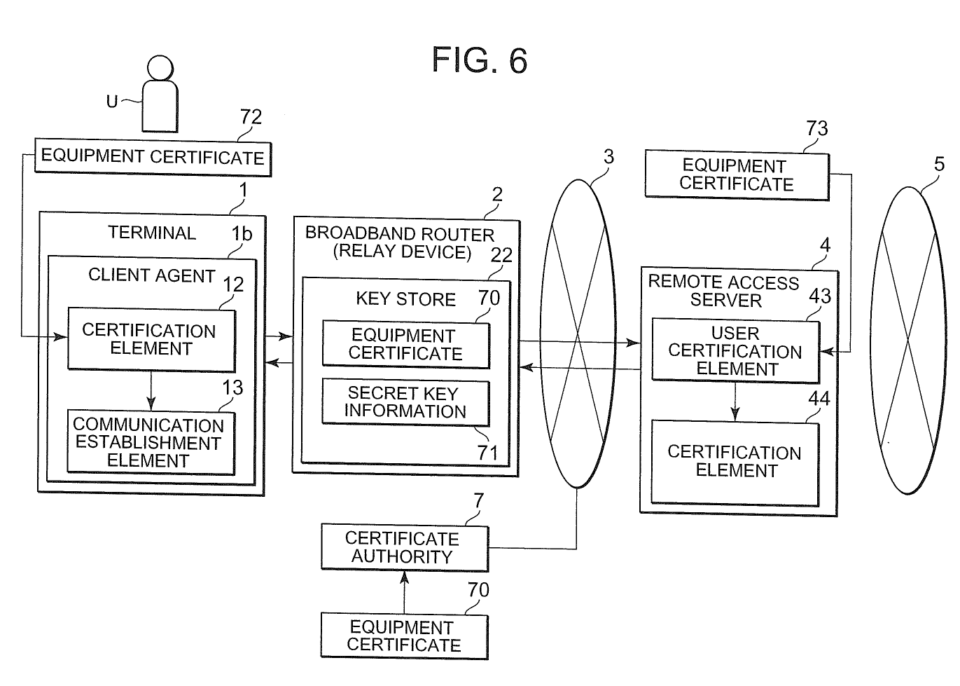

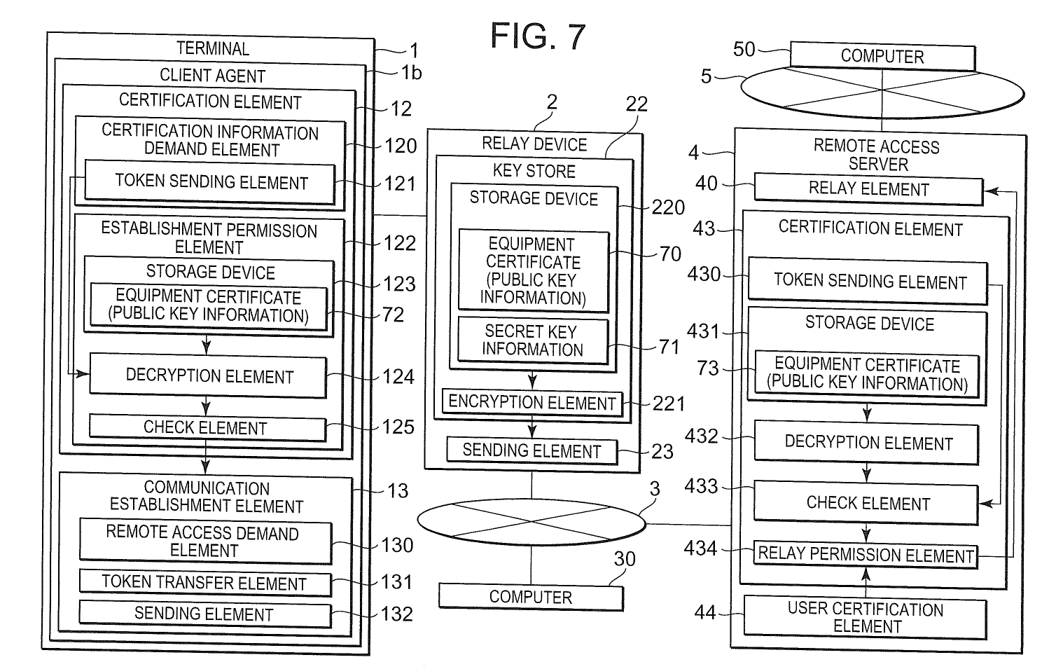

FIG. 6 and FIG. 7 show a telecommunication system with a relay device certification function of the second embodiment of the present invention.

The telecommunication system of the second embodiment of the present invention includes a terminal 1, a relay device 2, and the remote access server 4.

Further, it differs from the first embodiment in respect of the following.

In the telecommunication system of this embodiment, instead of the equipment ID's 60 to 62 which are specific information of the broadband router 2, public key information and secret key information 71 which are a pair of cryptographic keys used in the cryptocommunication system, such as RSA, are used. These public key information and secret key information 71 are made in advance by the manufacture vendor of the broadband router 2. The public key information is included in an equipment certificate 70 together with the identification information of the manufacture vendor, the identification information for identifying the equipment, etc.

Moreover, in manufacturing the broadband router 2, the manufacture vendor makes a keystore 22 provided in the broadband router 2 store the equipment certificate 70 and the secret key information 71 in advance.

A certification element 12 of terminal 1 and a certification element 43 of remote access server 4 are verifying the broadband router 2 using the equipment certificate 70 including the public key information.

Below, a configuration of the telecommunication system will be explained in more detail.

As shown also in FIG. 7, the certification element 12 of terminal 1 has, similarly as the first embodiment, a certification information demand element 120, and an establishment permission element 122.

A certification information demand element 120 has a token sending element 121. The token sending element 121 makes an arbitrary token, and sends it towards the broadband router 2. Here, a token is a passphrase made up of a random value of an arbitrary number of bits.

This token sending element 121 makes a new token each time a signal demanding the certification information is sent to the broadband router 2.

In this embodiment, when sending the certification information demand signal to the broadband router 2, the token sending element 121 of terminal 1 sends this certification information demand signal in which the token is included.

Moreover, the establishment permission element 122 has a storage device 123, a decryption element 124, and the check element 125. The storage device 123 stores the public key information of the broadband router 2 for permitting connection. The decryption element 124 decrypts the certification information sent from the broadband router 2 with the public key information. When the certification information decrypted by the decryption element 124 and the token sent by the token sending element 121 are in agreement, a check element 125 certifies that the certification information is correct.

The storage device 123 stores an equipment certificate 72 of the broadband router 2 which is the relay device such that security of the network on the LAN side thereof is fully secured.

When the certification information which the certification information demand element 120 received is passed to the decryption element 124, the decryption element 124 takes out the public key information from the equipment certificate 70 stored in the storage device 123 and decrypts the encrypted token which is the certification information.

When the storage device 123 stores a plurality of equipment certificates 72, the decryption element 124 of terminal 1 allows the user to select an equipment certificate by which decryption is performed.

Moreover, the check element 125 of terminal 1 also receives a token sent by the token sending element 121, and finds whether this token and the decrypted certification information are in agreement.

The communication establishment element 13 has a remote access demand element 130, a token transfer element 131, and a sending element 132.

The remote access demand element 130 demands of the remote access server 4 to establish the communication path to the computer 50 in another network.

The token transfer element 131 transfers the token sent from the remote access server 4 to the broadband router 2. The sending element 132 transfers the certification information corresponding to the token sent from the remote access server 4 to the remote access server 4.

Upon reception of the token sent from a below-mentioned token sending element 430 of remote access server 4, the token transfer element 131 transfers this to the broadband router 2 side. More specifically, the token sending element 430 transfers the token sent from the remote access server 4 to the broadband router 2 through the certification element 12 of terminal 1.

The sending element 132 receives the certification information from the broadband router 2 via the certification element 12, and transfers this to the remote access server 4.

In addition, the terminal 1 has an equipment certificate verification element (not illustrated) for verifying the equipment certificate 70. The certificate verification element is configured to be capable of verifying whether the equipment certificate 70 is particular to the broadband router 2 or not. This verification is done by the terminal 1 accessing the below-mentioned certification authority 7 and performing predetermined certification communication.

The broadband router 2 has the keystore 22 and the sending element 23.

The keystore 22 is equipped with a storage device 220 and an encryption element 221.

The storage device 220 stores the secret key information 71 of the broadband router 2. The encryption element 221 makes an encrypted token by encrypting the token sent from the terminal 1 with the secret key information 71.

The storage device 220 stores the equipment certificate 70 in addition to the secret key information 71.

The encryption element 221 calculates an encrypted token by performing standard encryption calculation on a token, without taking out the secret key information 71 to the outside. The encrypted token calculated by this encryption element 221 is passed to the sending element 23.

The keystore 22 has an unillustrated certification element. The certification element asks for the input of a password, and when the password is correct, the keystore 22 itself enables the equipment certificate 70 of the storage device 220 to be outputted, and makes it possible for the encryption element 221 to encrypt the token.

The equipment certificate 70 of the storage device 220 can be taken out by inputting a password into the certification element.

Incidentally, the password of the keystore 22 is written in, for example, an instruction manual of the broadband router 2, and can be changed by the user U itself.

The keystore 22 is equipped with the tamper resistant function. The tamper resistant function is a function of, when attempting to decompose the broadband router 2 in order to take out the data physically, making it impossible to take out the data by destroying the storage device 220 of the broadband router 2, for example.

For this keystore 22, hardware, for example, an IC card, a TPM (Trusted Platform Module), or the like is used. Alternatively, the keystore 22 may be realized by software stored in the storage device which the broadband router 2 is equipped with and an arithmetic processing unit for executing this software instead of the hardware.

Therefore, if the secret key information 71 is stored in the storage device 220 of relay device 2, it becomes impossible to take out the secret key information 71 to the outside of the keystore 22.

Upon reception of the certification information sending demand signal from the terminal 1, the sending element 23 takes out the token included in this and passes it to the encryption element 221 of the keystore 22. Moreover, the sending element 23 sends an encrypted token received from the encryption element 221 to the terminal 1 as certification information.

The remote access server 4 is made up of the same computer as computer of the first embodiment.

The certification element 43 of remote access server 4 has a token sending element 430, a storage device 431, a decryption element 432, a check element 433, and a relay permission element 434.

The storage device 431 of remote access server 4 stores the equipment certificate 70 which permits the relaying of the communication path.

When there is a remote access demand from the communication establishment element 13, the token sending element 430 of remote access server 4 makes an arbitrary token towards the terminal 1, and sends it to the broadband router 2. The decryption element 432 of remote access server 4 decrypts certification information sent from the broadband router 2 with the public key included in an equipment certificate 73. The check element 433 of remote access server 4 finds whether or not the certification information decrypted by the decryption element 432 and the token sent by the token sending element 430 are in agreement. When the check element 433 of remote access server 4 finds the agreement, the relay permission element 434 permits the relay element 40 to relay the communication path to a computer 50 in another network.

Similarly as the above, the storage device 431 of remote access server 4 stores the equipment certificate of a relay device (broadband router 2) such that the security of the network on the LAN side thereof is fully secured.

Upon reception of the remote access demand signal from the remote access demand element 130, the token sending element 430 of remote access server 4 makes a token and sends this to the terminal 1 side. The made token is the same as the token made by the above-mentioned certification information demand element 120.

The decryption element 432 of remote access server 4 decrypts the certification information sent from the terminal 1 with, for example, the public key information of all the equipment certificates 70 stored in the storage device 431 of remote access server 4.

The check element 433 of remote access server 4 compares all pieces of the certification information which were decrypted with the public key information of the respective equipment certificates 70 and the token, and checks whether these pieces of certification information and the token are in agreement or not.

The relay permission element 434 permits the relay element 40 to relay the communication path corresponding to the terminal 1 which has sent thereto the certification information that the agreement was found.

The terminal 1 has the same certificate verification element (not illustrated) as that of the terminal 1.

The manufacture vendor has formed a certificate authority 7 connected to the Internet 3. The certificate authority 7 issues a manufacturer certificate authority certificate (not illustrated). Then, the manufacturer certificate authority certificate forms a certification path for certifying the equipment certificate 70 which has that as a peak.

That is, this manufacturer certificate authority certificate is used as a reliance certificate in the verification process of the equipment certificate 70 stored in the terminal 1, the broadband router 2, and the remote access server 4.

Therefore, other constituents are specified to be the same as those of the first embodiment. The same constituents are designated by the same numerals as those of the first embodiment in the figures and their detailed explanations are omitted.

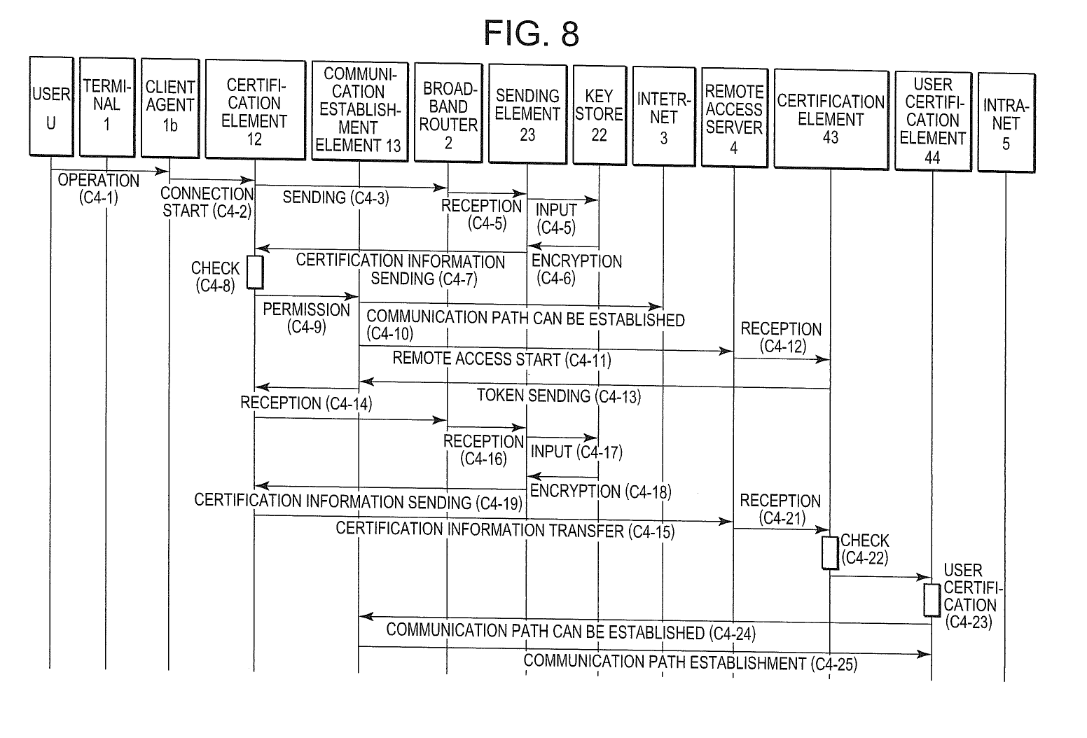

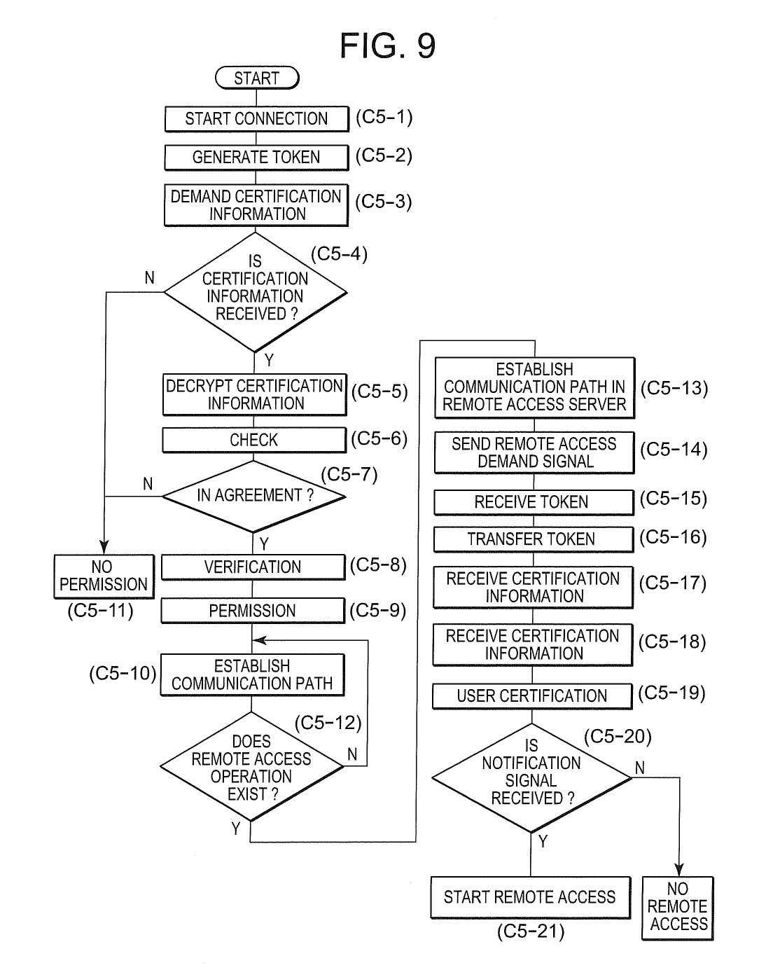

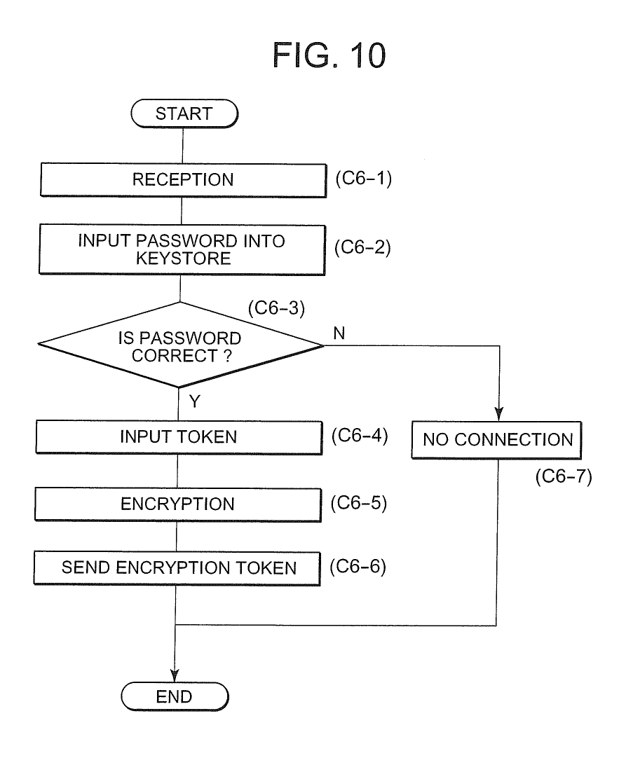

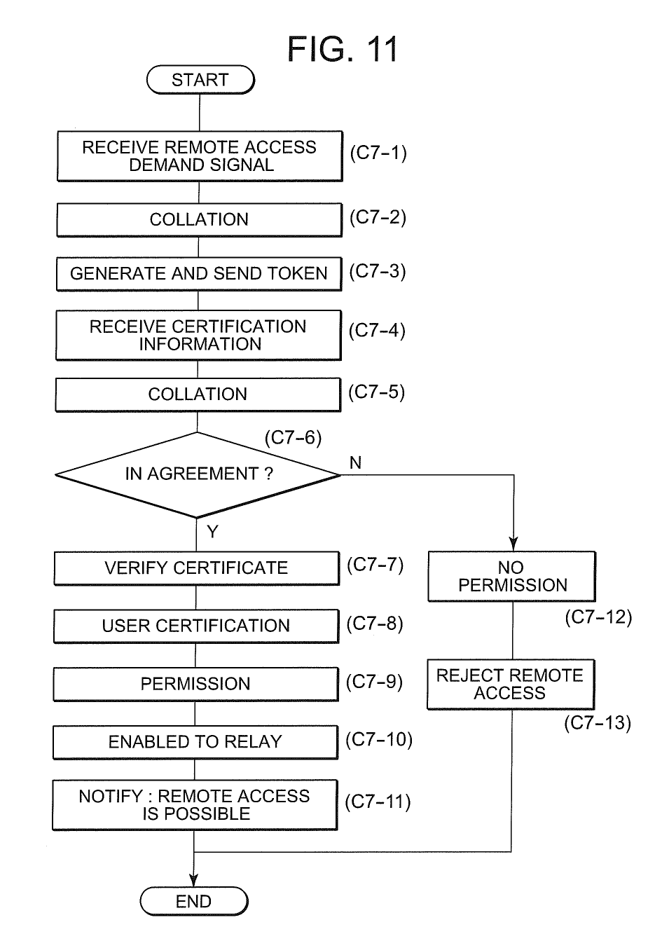

Next, operations (actions) of the telecommunication system of this embodiment which includes the above configuration will be explained according to the charts shown in FIGS. 8 to 10. Incidentally, FIG. 8 shows a sequence diagram of the whole telecommunication system, and FIG. 9 shows a flowchart diagram of the terminal 1, FIG. 10 shows a flowchart diagram of the broadband router 2, and FIG. 11 shows a flowchart diagram of remote access server 4. First, security environment of the network on the LAN side of the broadband router 2 is checked up in advance. Then, when the security is fully secured, a password is inputted into the keystore 22 of the broadband router 2, and the equipment certificate 70 is taken out from the storage device 220.

Subsequently, it is stored in the storage device 123 of terminal 1 and the storage device 431 of remote access server 4.

Next, the user U takes the terminal 1 home, and connects it with the broadband router 2.

The terminal 1 recognizes that the client agent 1b is connected with the broadband router 2. Under this circumstance, the communication establishment element 11 has no permission sent from the establishment permission element 122, and connection to the Internet 3 is not established.

In this state, when the terminal 1 performs the first communication with the Internet 3 side through the broadband router 2 (Step C4-1), the client agents 1b detects this (Steps C4-2, C5-1), and the certification information demand element 120 of terminal 1 establishes the communication path between the terminal 1 and the broadband router 2 on the terminal 1 side.

Next, the token sending element 121 of terminal 1 makes a 256-bit token of a random value (Step C5-2). Then, the certification information demand element 120 sends a signal which demands the certification information including a token to the broadband router 2 (Steps C4-3, C5-3).

In this time, the certification information demand element 120 asks the user U so that a password of the certification element of the keystore 22 may be inputted. The certification information demand element 120 includes the inputted password into the certification information demand signal.

When the broadband router 2 receives the signal demanding the certification information (Steps C4-4, C61), the sending element 23 takes out a password of the keystore 22 from the certification information demand signal, and inputs it into the certification element of the keystore 22 (Step C6-2).

When the certification element 12 finds that the input password is correct (Step C6-3Y), the certification information demand signal sends a token into the encryption element 221 (Steps C4-5, C6-4).

When the token is inputted, the encryption element 221 encrypts the token with the secret key information 71 stored in the storage device 220, and outputs the encrypted token to the certification information demand element 120 (Steps C4-6, C6-5).

When the encrypted token is inputted, the certification information demand element 120 sends this encrypted token as certification information to the terminal 1 (Step C4-7).

Upon reception of the certification information, the terminal 1 inputs this certification information into the decryption element 124 of terminal 1 (Step C5-5).

The decryption element decrypts the certification information with the public key information included in the equipment certificate 72 stored in the storage device 123, and outputs the decrypted certification information to the check element 125 of terminal 1.

In the check element 125 of terminal 1, the token which the token sending element 121 sent to the broadband router 2 is input in advance. And the check element 125 finds whether the token and the decrypted certification information are in agreement (Steps C4-8, C5-6).

When the token and the decrypted certification information are in agreement (Step C5-7Y), the terminal 1 accesses the certificate authority 7 with a certificate verification element and verifies whether the equipment certificate 72 is particular to the broadband router 2 or not (Step C5-8).

Then, when the equipment certificate 72 is particular to the broadband router 2, the establishment permission element 122 permits the communication establishment element 13 to establish the communication path (Steps C4-9, C5-9).

In this case, the communication establishment element 13 makes it possible to establish the communication path to the Internet 32 side, which enables the terminal 1 to communicate with the computer 30 on the Internet 3 side (Steps C4-10, C5-10).

On the other hand, when the terminal 1 cannot receive the certification information, the terminal 1 sends out a sending demand signal again similarly as the first embodiment. If the certification information cannot be received even after this is repeated the predetermined number of times (Step C5-4N), the establishment permission element 122 does not permit the communication establishment element 13 to establish the communication paths either to the Internet 3 or to the network on the LAN side of the broadband router 2 (Step C5-11).

On the other hand, when the certification element of the broadband router 2 finds that the password is not correct, the broadband router 2 sends to the terminal 1 side a signal of unconnectability to the broadband router 2 (Step C6-7). In this case, the establishment permission element 122 of the terminal 1 does not permit the establishment of the communication path by the communication establishment element 13 (Steps C5-4N, C5-12).

Moreover, if the check element 125 of terminal 1 finds that the token and the decrypted certification information are in disagreement, or if a certificate verification element finds that an equipment certificate 72 is not particular with the broadband router 2, the establishment permission element 122 dose not permit the establishment of the communication path by the communication establishment element 13. Therefore, the terminal 1 does not perform communication with either the Internet 3 or the network on the LAN side of the broadband router 2. Next, when the user U peruses a file of the file server 50 in the intranet 5 with the terminal 1 (Step C5-12), the communication establishment element 13 establishes the communication path between the terminal 1 and the remote access server 4 (Step C5-13). Then, in order to communicate with the file server 50 by the remote access demand element 130, the remote access demand element 130 sends out a remote access demand signal to the remote access server 4 (Steps C4-11, C5-14).

When the remote access server 4 receives the remote access demand signal (Steps C4-12, C7-1), the token sending element 430 makes a 256-bit token of a random value, which is sent to the terminal 1 from broadband router 2 (Steps C4-13, C7-2).

Next, when the terminal 1 receives the token from the remote access server 4 (Steps C4-14, C5-15), the token transfer element 131 of terminal 1 transfers the token to the broadband router 2 through the certification information demand element 120 of terminal 1 (Steps C4-15, C5-16).

In this time, the certification information demand element 120 sends a token receiving from the remote access server 4 instead of the token made by the token sending element 121 of terminal 1, being included in the certification information demand signal, to the broadband router 2.

When the broadband router 2 receives this certification information demand signal, it performs the same processing as that of the above to encrypt the token with the encryption element 221, and sends the encrypted token to the terminal 1 as certification information (Steps C4-16 to 19, and C6-1 to 6).

When the certification information demand element 120 of the terminal 1 receives the certification information corresponding to the token sent from the remote access server 4 (Step C5-17), the sending element 132 of the terminal 1 detects this certification information and transfers this certification information to the remote access server 4 (Steps C4-20, C5-18).

Upon reception of the transferred certification information (Steps C4-21, C7-3), the remote access server 4 decrypts the certification information with the public key information included in the equipment certificate 70 stored in the storage device 431 (Step C7-4).

In this time, if there are the plurality of equipment certificates 73 stored in the storage device 431 of remote access server 4, the decryption elements 432 of remote access server 4 decrypts the certification information with the public key information included in all the equipment certificates 73.

Then, the check element 433 of remote access server 4 collates these all pieces of the decrypted certification information with the token sent by the token sending element 430 of remote access server 4 (Steps C4-22, C7-5).

When the check element 433 of remote access server 4 finds that one piece of the decrypted certification information is in agreement with the token sent by the token sending element 430 (Step C7-6Y), the certificate verification element verifies whether the equipment certificate 73 is correct or not. When the verification is successful, in the similar fashion as the user certification of the above-mentioned first embodiment, the user certification information is received from the terminal 1, and the user certification element 42 performs certification of the user U (Steps C4-23, C5-19, and C7-8).

When the user certification element 44 performed the certification of the user U correctly, the check element 433 of remote access server 4 permits the broadband router 2 to perform relaying, which enables the relay element 40 to relay the communication path (Step C7-10).

A signal notifying that the communication path can be established to the file server 50 in the intranet 5 is sent out to the communication establishment element 13 of the terminal 1 (Steps C4-24, C7-11).

Then, upon reception of this notification signal (Steps C4-23, C5-20Y), the communication establishment element 13 establishes the communication path for the file server 50 in the intranet 5 and performs communication with the file server 50 (Steps C4-25, C5-21).

In addition, in other case than the above, for example, a case where the decrypted certification information is different from the token made by the token sending element 430 of remote access server 4, the communication establishment element 13 does not permit the relay element 40 to relay the communication path from the terminal 1 to the intranet 5. Then, the user certification element 44 sends out a signal which rejects a remote access to the terminal 1.

When the terminal 1 receives the signal of rejecting a remote access (Step C5-20N), the communication establishment element 13 can no longer establish the communication path to a file server 50, whereby no remote access can be made.

As explained above, according to the telecommunication system concerning this embodiment, the public key information and the secret key information 71 which are included in the equipment certificate 70 are used, and the secret key information 71 can be prevented from leaking to the others, even provided that the communication path that the terminal 1 has established is intercepted.

Therefore, a situation where a most adjacent broadband router fakes, as if it is a proper broadband route 2, is prevented.

In addition, a situation where a false router pretending the proper broadband router 2 remote accesses the remote access server 4 is almost prevented and the security performance of the telecommunication system can be improved.

In the foregoing, although the equipment of the present invention was explained by illustrating the preferred embodiments, the equipment according to the present invention is not limited only to the embodiments described above. It is natural that various modifications are possible within the spirit and scope of the present invention.

It is not limited to that the relay device 2 is a broadband router 2: it may be configured that the certification information sending elements are provided in nodes each of which can communicate through a network, the certification information is received from them, and the terminal receives the certification information from all of them.

Although the decryption element of terminal 1 allowed the user to select the equipment certificate, it may be configured that the data is decrypted with each equipment certificate stored in the storage device of terminal 1, and the check element compares between all pieces of the decrypted certification information and the token.

Moreover, although in this embodiment of the prevent invention it is configured as that the equipment certificate is selected by user, it is also possible to configure as that the certification information decrypted by all equipment certificate and the token is compared.

However it is not limited to this. For example, It may be configured that information as to which equipment certificate was selected is received in advance from the terminal, and the decryption element of remote access server 4 decrypts the equipment certificate corresponding to this.

While this invention has been described in conjunction with the preferred embodiments described above, it will now be possible for those skilled in the art to put this invention into practice in various other manners.

What is claimed is:

1. Telecommunication system comprising:
a terminal; and
a relay device which relays a communication path established on a network by said terminal,
wherein said relay device sends certification information based on a demand of said terminal and said terminal checks whether said certification information is correct or not and said terminal establishes a communication path on said network when said certification information is correct.

2. The telecommunication system according to claim 1, further comprising:
a remote access server which can relay a communication path between said network and other network,
wherein said terminal sends said certification information to said remote access server when said communication path on said network is established,
wherein said remote access server checks whether said certification information received from said terminal is correct or not, and
wherein said terminal establishes a communication path on said other network when said certification information is correct.

3. The telecommunication system according to claim 2,
wherein said first and second certification information are information of said relay device.

4. The telecommunication system according to claim 1,
wherein said relay device encrypts a first token, which is made by said terminal, with secret key information when said relay device is received said first token from said terminal and sends said encrypted first token to said terminal as said certification information and
wherein said terminal decrypts said encrypted first token with public key information.

5. The telecommunication system according to claim 4, further comprising:
a remote access server which can relay a communication path between said network and other network,
wherein said terminal sends said certification information to said remote access server when said communication path on said network is established,
wherein said remote access server checks whether said certification information received from said terminal is correct or not, and
wherein said terminal establishes a communication path on said other network when said second certification information is correct.

6. The telecommunication system according to claim 5,
wherein said relay device encrypts second token, which is made by said remote access server, with said secret key information when said relay device is received said second token from said remote access server,
wherein said relay device sends said encrypted second token to said remote access server through said terminal as said certification information, and
wherein said remote access server decrypts said encrypted second token with said public key information.

7. The telecommunication system according to claim 1,
wherein said terminal includes:
a communication establishment element which establishes a communication path on a network;
a certification information demand element which demands said relay device to send said certification information to said terminal; and
an establishment permission element which permits said communication establishment element to establish a communication path on said network when said certification information received from said relay device is correct, and
wherein said relay device includes a sending element which sends said certification information based on a demand of said terminal.

8. The telecommunication system according to claim 7,
wherein said establishment permission element includes:
a storage device which has information of said relay device to be permitted to connect; and
a check element which checks whether said certification information received from said relay device is correct or not, and
wherein said relay device includes a storage device which has information of said relay device and said sending element sends said information of said relay device as said certification information.

9. The telecommunication system according to claim 8, further comprising:
a remote access server which includes a relay element which can relay a communication path between said network and other network,
wherein said communication establishment element includes:
a remote access demand element which demands said remote access server to establish a communication path on said other network; and
a sending element which sends said certification information to said remote access server, and
wherein said remote access server includes:
a storage device which has information of said relay device to be permitted to relay a communication path;
a reception element which receives a remote access demand from said remote access demand element and receives said certification information from said sending element of said terminal;
a check element which checks whether said received certification information is the same as said information of said relay device; and
a relay permission element which permits said relay element to relay a communication path to a computer in said other network when said received certification information is the same as said information of said relay device.

10. The telecommunication system according to claim 7,
wherein said certification information demand element includes:
a token transfer element which makes a first token and sends said first token to said relay device,
wherein said establishment permission element includes:
a storage device which has public key information of said relay device to be permitted to connect;
a decryption element which decrypts said certification information received from said relay element with said public key information; and
a check element which checks whether said decrypted first certification information is the same as said first token sent from said token transfer element,
wherein said relay device includes:
a storage device which has secret key information of said relay device; and
an encryption element which encrypts said first token with said secret key information, and
wherein said certification information sending element sends said encrypted first token as said certification information.

11. The telecommunication system according to claim 10, further comprising:
a remote access server which includes a relay element which can relay a communication path between said network and other network,
wherein said remote access server includes:
a storage device which has said public key information of said relay device permitted to relay a communication path;
a token sending element which makes a second token based on a remote access demand of said communication establishment element and sends said second token for said relay device through said terminal;
a decryption element which decrypts said certification information with said public key information;
a check element which checks whether said decrypted certification is the same as said second token sent by said token sending element or not; and
a relay permission element which permits said relay element to relay a communication path to a computer in said other network when said received certification information is the same as said information of said relay device, and
wherein said communication establishment element includes:
a remote access demand element which demands said remote access server to establish a communication path on said other network;
a token transfer element which sends said second token received from said remote access server to said relay device; and
a sending element which sends said certification information received from said relay device to said remote access server.

12. Telecommunication method in a system which has a terminal and a relay device which relays a communication path established on a network by said terminal, the telecommunication method comprising the step of:
demanding said relay device to send certification information;
checking whether said certification information is correct or not; and
establishing a communication path on said network when said certification information is correct.

13. The telecommunication method according to claim 12, the telecommunication method comprising the step of:
said terminal sending said certification information for a remote access server, which enables to relay a communication path between said network and other network, when said communication path on said network is established;
said remote access server checking whether said certification information received from said terminal is correct or not; and
said terminal establishing a communication path on said other network when said certification information is correct.

14. The telecommunication method according to claim 13, wherein said first and second certification information are information of said relay device.

15. The telecommunication method according to claim 12, the telecommunication method comprising the step of:
said relay device encrypting a first token, which is made by said terminal, with secret key information when said relay device is received said first token from said terminal;
said relay device sending said encrypted first token for said terminal as said certification information; and
said terminal decrypting said encrypted first token with public key information.

16. The telecommunication method according to claim 15, the telecommunication method comprising the step of:
said terminal sending said certification information for said remote access server, which enables to relay a communication path between said network and other network, when said communication path on said network is established;
said remote access server checking whether said certification information received from said terminal is correct or not; and
said terminal establishing a communication path on said other network when said second certification information is correct.

17. A terminal connected to a relay device which relays a communication path established on a network by said terminal, the terminal comprising:
a communication establishment element which establishes a communication path on a network;
a certification element which demands said relay device to send said certification information for said terminal and which permits said communication establishment element to establish a communication path on said network when said certification information received from said relay device is correct.

18. The terminal according to claim 17, wherein said certification element includes;
a storage device which has information of said relay device to be permitted to connect; and
a check element which determines that said certification information is correct by checking that said certification information received from said relay device is the same as said information of said relay device.

19. The terminal according to claim 18, wherein said terminal is connected to a remote access server which enables to relay a communication path between said network and other network, and
wherein said communication establishment element demands said remote access server to establish a communication path on said other network with said certification information for said remote access server.

20. The terminal according to claim 17, wherein said certification element includes:
a storage device which has a public key information of said relay device to be permitted to connect;
a token sending element which makes a first token and sends said first token for said relay device;
a decryption element which decrypts said certification information, which is encrypted by said relay device and received from said relay device, with said public key information; and
a check element which checks whether said decrypted first certification information is same as said first token send from said relay device.

21. The terminal according to claim 20, wherein said communication establishment element demands said remote access server to establish a communication path on said other network and sends said second token received from said remote access server for said relay device with said certification information received from said relay device.

22. A remote access server in system which has a terminal and a relay device which relays a communication path established on network by said terminal, the remote access server comprising:
a relay element which enables to relay a communication path between said network and other network; and
a certification element which receives a remote access demand from said terminal and which permits said relay element to relay a communication path to a computer in said other network by checking that said received certification information is correct.

23. A remote access server according to claim 22, wherein said certification element includes:
a storage device which has information of said relay device to be permitted to relay a communication path;
a check element which checks whether said received certification information is same as said information of said relay device; and
a relay permission element which permits said relay element to relay a communication path to a computer in said other network when said received certification information is same as said information of said relay device.

24. The remote access server according to claim 22, wherein said certification element includes:
a storage device which has information of said relay device to be permitted to relay a communication path;
a token sending element which makes a second token based on a remote access demand of terminal and sends said second token for said relay device through said terminal;
a decryption element which decrypts said certification information with public key information;
a check element which checks whether said decrypted certification is same as said second token send by said token sending element or not; and
a certification element which permits said relay element to relay a communication path to a computer in said other network when said received certification information is same as said information of said relay device.
